(19) United States
(12) Patent Application Publication
(10) Pub. No.: US 2018/0136764 A1
(43) Pub. Date: May 17, 2018

(54) Electronic Calendar Assembly

(71) Applicant: Willie Moore, Norwalk, CT (US)

(72) Inventor: Willie Moore, Norwalk, CT (US)

(21) Appl. No.: 15/352,757

(22) Filed: Nov. 16, 2016

(51) Int. Cl. G06F 3/041; G04B 19/24; G04G 13/02; G04G 21/08

(52) U.S. Cl. CPC G06F 3/0412; G04B 19/24; G06F 2203/04103; G04G 21/08; G04G 13/02

(57) ABSTRACT

A electronic calendar assembly includes a housing that may be positioned on a support surface. A processor is positioned within the housing and the processor selectively generates an alarm sequence. An electronic memory is positioned within the housing and the electronic memory is electrically coupled to the processor. The electronic memory stores data pertains to a month by month calendar. A touch screen is coupled to the housing and the touch screen may be manipulated. The touch screen is electrically coupled to the processor. A button is coupled to the housing and the button is selectively manipulated. The button is electrically coupled to the processor such that the button turns the alarm sequence off when the button is manipulated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to calendar devices and more particularly pertains to a new calendar device for keeping track of appointments

### BRIEF SUMMARY OF THE INVENTION

An embodiment of the disclosure meets the needs presented above by generally comprising a housing that may be positioned on a support surface. A processor is positioned within the housing and the processor selectively generates an alarm sequence. An electronic memory is positioned within the housing and the electronic memory is electrically coupled to the processor. The electronic memory stores data pertains to a month by month calendar. A touch screen is coupled to the housing and the touch screen may be manipulated. The touch screen is electrically coupled to the processor. A button is coupled to the housing and the button is selectively manipulated. The button is electrically coupled to the processor such that the button turns the alarm sequence off when the button is manipulated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a electronic calendar assembly according to an embodiment of the disclosure.

FIG. 2 is a right side view of an embodiment of the disclosure.

FIG. 3 is a back phantom view of an embodiment of the disclosure.

FIG. 4 is a schematic view of an embodiment of the disclosure.

FIG. 5 is a perspective in-use view of an embodiment of the disclosure.

### DETAILED DESCRIPTION OF THE INVENTION

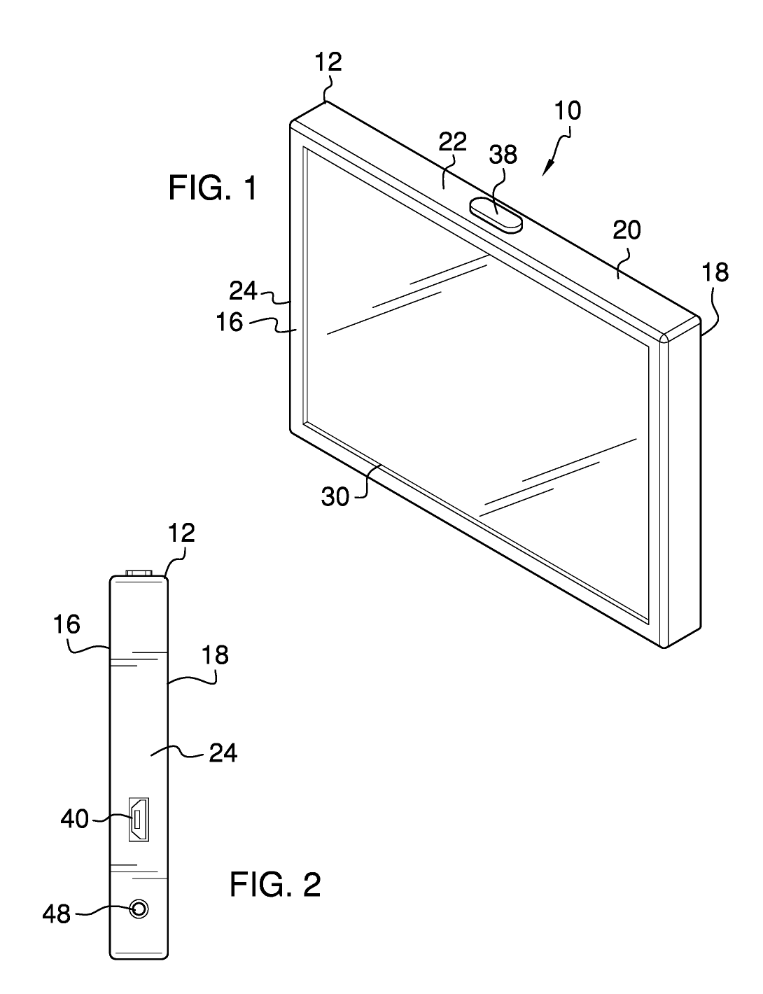

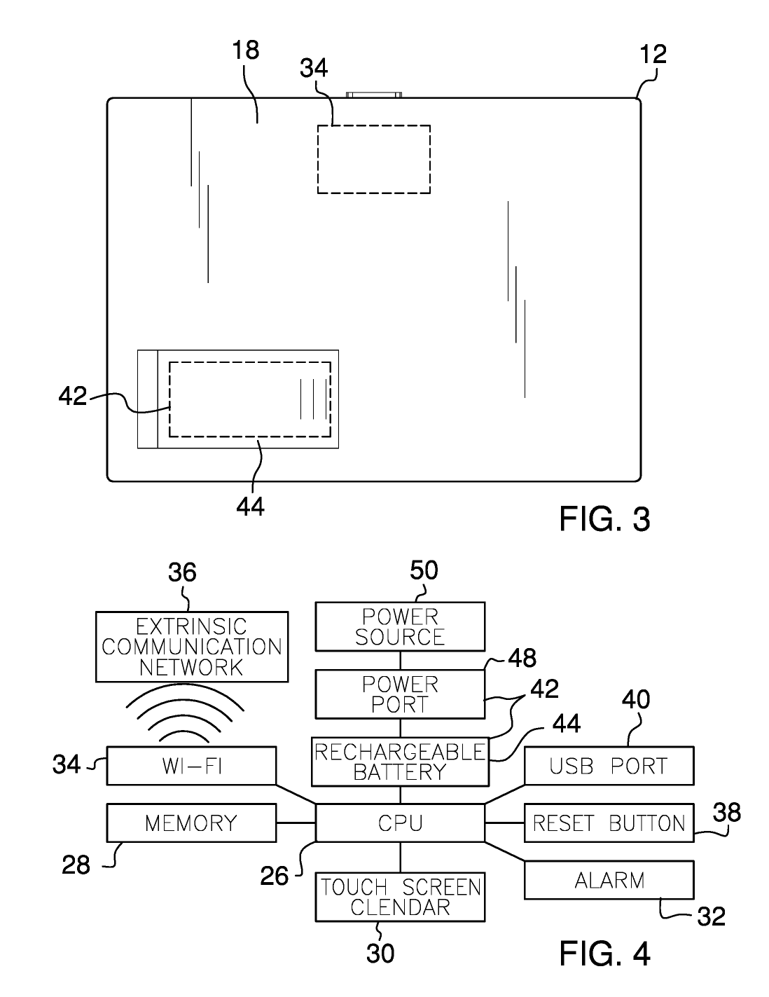

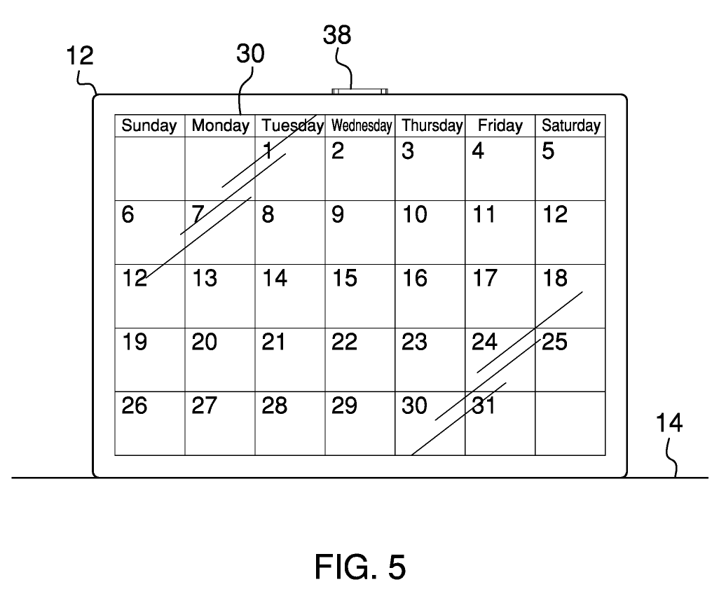

With reference now to the drawings, and in particular to FIGS. 1 through 5 thereof, a new calendar device embodying the principles and concepts of an embodiment of the disclosure and generally designated by the reference numeral 10 will be described.

As best illustrated in FIGS. 1 through 5, the electronic calendar assembly 10 generally comprises a housing 12 that may be positioned on a support surface 14. The support surface 14 may be a desk top or the like. The housing 12 has a front side 16, a back side 18 and a peripheral edge 20 extending therebetween. The peripheral edge 20 has a top side 22 and a first lateral side 24.

A processor 26 is positioned within the housing 12 and the processor 26 selectively generates an alarm sequence. The processor 26 may be an electronic processor 26 or the like. An electronic memory 28 is positioned within the housing 12 and the electronic memory 28 is electrically coupled to the processor 26. The electronic memory 28 stores data pertaining to a month by month calendar. The electronic memory 28 may be RAM memory, a hard disk drive or other means of electronic data storage.

A touch screen 30 is provided and the touch screen 30 is coupled to the housing 12 and the touch screen 30 may be manipulated. The touch screen 30 is electrically coupled to the processor 26. The touch screen 30 displays indicia 31 corresponding to the month by month calendar thereby facilitating the touch screen 30 to record an event in the electronic memory 28 for a selected day on the month by month calendar when the touch screen 30 is manipulated. The touch screen 30 displays a visual alarm for the event recorded in the electronic memory 28 twenty four hours prior to the event when the processor 26 generates the alarm sequence. The touch screen 30 may be an LED touch screen 30 or the like and the event may be a prescheduled appointment, a birthday, a holiday or any other event.

A speaker 32 is provided and the speaker 32 is coupled to the housing 12. The speaker 32 selectively emits an audible alarm. The speaker 32 is electrically coupled to the processor 26 such that the processor 26 turns the speaker 32 on when the processor 26 generates the alarm sequence. The speaker 32 may be an electronic speaker 32 of any conventional design.

A transceiver 34 is provided and the transceiver 34 is positioned within the housing 12. The transceiver 34 is electrically coupled to the processor 26. The transceiver 34 is in electrical communication with an extrinsic communication network 36 thereby facilitating the transceiver 34 to receive a time of day from the extrinsic communication network 36. The extrinsic communication network 36 may be the internet or the like and the transceiver 34 may receive the time of day from the atomic clock in Denver Colo. In this way the processor 26 keeps track of the current date and time. The transceiver 34 may be a radio frequency transceiver 34 that uses a WPAN signal.

A button 38 is coupled to the housing 12 and the button 38 may be manipulated. The button 38 is electrically coupled to the processor 26 such that the button 38 turns the alarm sequence off when the button 38 is manipulated. An input port 40 is coupled to the housing 12 and the input port 40 is electrically coupled to the processor 26. The input port 40 may electrically coupled to an electronic device thereby facilitating the processor 26 to communicate with the electronic device. The input port 40 may be a usb port or the like and the electronic device may be a personal computer or the like. Moreover, the processor 26 may receive electronic data from the electronic device.

A power supply 42 is provided and the power supply 42 is coupled to the housing 12. The power supply 42 is electrically coupled to the processor 26. The power supply 42 comprises at least one battery 44 that is positioned in the housing 12. A battery cover 46 is removably coupled to the back side 18 of the housing 12 and the battery 44 is positioned beneath the battery cover 46.

A charge port 48 is provided and the charge port 48 is coupled to the housing 12. The charge port 48 is electrically coupled to the at least one battery 44. Moreover, the charge port 48 may be electrically coupled to a power source 50 thereby facilitating the at least one battery 44 to be charged. The power source 50 may an external battery charger or the like.

In use, the housing 12 is positioned on the support surface 14. The touch screen 30 is manipulated to record the event on the selected day of the month. The processor 26 generates the alarm sequence 24 hours prior to the event. The day corresponding to the event on the month by month calendar flashes on and off and the speaker 32 emits the audible alarm. In this way the processor 26 reminds a user of the event. The button 38 is manipulated to turn off alarm sequence.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electronic calendar assembly being configured to remind a user of upcoming events, said assembly comprising:
a housing being configured to be positioned on a support surface such that a front side of said housing is perpendicular to the support surface;
a processor being positioned within said housing, said processor selectively generating an alarm sequence;
an electronic memory being positioned within said housing, said electronic memory being electrically coupled to said processor, said electronic memory storing data pertaining to a month by month calendar;
a touch screen being coupled to said housing wherein said touch screen is configured to be manipulated, said touch screen being electrically coupled to said processor, said touch screen being positioned on said front side of said housing; and
a button being coupled to said housing wherein said button is configured to be manipulated, said button being positioned on a peripheral edge of said housing perpendicular to said front side such that said button is configured to face away from the support surface and said button is depressed by motion towards the support surface, said button being electrically coupled to said processor such that said button turns said alarm sequence off when said button is manipulated.

2. The assembly according to claim 1, further comprising said housing having said front side, a back side and said peripheral edge extending therebetween.

3. The assembly according to claim 1, wherein said touch screen displays indicia corresponding to said month by month calendar thereby facilitating said touch screen to record an event in said electronic memory for a selected day on said month by month calendar when said touch screen is manipulated.

4. The assembly according to claim 3, wherein said touch screen displaying a visual alarm for said event recorded in said electronic memory twenty four hours prior to said event when said processor generates said alarm sequence.

5. The assembly according to claim 1, further comprising a speaker being coupled to said housing wherein said speaker is configured to emit an audible alarm, said speaker being electrically coupled to said processor such that said processor turns said speaker on when said processor generates said alarm sequence.

6. The assembly according to claim 1, further comprising a transceiver being positioned within said housing, said transceiver being electrically coupled to said processor, said transceiver being configured to be in electrical communication with an extrinsic communication network thereby facilitating said transceiver to receive a time of day from the extrinsic communication network.

7. The assembly according to claim 1, further comprising an input port being coupled to said housing, said input port being electrically coupled to said processor, said input port being configured to be electrically coupled to an electronic device thereby facilitating said processor to communicate with the electronic device.

8. The assembly according to claim 1, further comprising a power supply being coupled to said housing, said power supply being electrically coupled to said processor.

9. The assembly according to claim 8, wherein said power supply comprises at least one battery being positioned in said housing.

10. The assembly according to claim 9, further comprising a charge port being coupled to said housing, said charge port being electrically coupled to said at least one battery, said charge port being configured to be electrically coupled to a power source thereby facilitating said at least one battery to be charged.

11. An electronic calendar assembly being configured to remind a user of upcoming events, said assembly comprising:
a housing being configured to be positioned on a support surface such that a front side of said housing is perpendicular to the support surface, said housing having said front side, a back side and a peripheral edge extending therebetween;
a processor being positioned within said housing, said processor selectively generating an alarm sequence;
an electronic memory being positioned within said housing, said electronic memory being electrically coupled to said processor, said electronic memory storing data pertaining to a month by month calendar;
a touch screen being coupled to said housing wherein said touch screen is configured to be manipulated, said touch screen being positioned on said front side of said housing, said touch screen being electrically coupled to said processor, said touch screen displaying indicia corresponding to said month by month calendar thereby facilitating said touch screen to record an event in said electronic memory for a selected day on said month by month calendar when said touch screen is manipulated, said touch screen displaying a visual alarm for said event recorded in said electronic memory twenty four hours prior to said event when said processor generates said alarm sequence;
a speaker being coupled to said housing wherein said speaker is configured to emit an audible alarm, said speaker being electrically coupled to said processor such that said processor turns said speaker on when said processor generates said alarm sequence;
a transceiver being positioned within said housing, said transceiver being electrically coupled to said processor, said transceiver being configured to be in electrical communication with an extrinsic communication network thereby facilitating said transceiver to receive a time of day from the extrinsic communication network;
a button being coupled to said housing wherein said button is configured to be manipulated, said button being positioned on said peripheral edge of said housing perpendicular to said front side such that said button is configured to face away from the support surface and said button is depressed by motion towards the support surface, said button being electrically coupled to said processor such that said button turns said alarm sequence off when said button is manipulated;
an input port being coupled to said housing, said input port being electrically coupled to said processor, said input port being configured to be electrically coupled to an electronic device thereby facilitating said processor to communicate with the electronic device; and
a power supply being coupled to said housing, said power supply being electrically coupled to said processor, said power supply comprising:
at least one battery being positioned in said housing, and
a charge port being coupled to said housing, said charge port being electrically coupled to said at least one battery, said charge port being configured to be electrically coupled to a power source thereby facilitating said at least one battery to be charged.
